(19) United States
(12) Patent Application Publication
(10) Pub. No.: US 2008/0103891 A1
(43) Pub. Date: May 1, 2008

(54) System and method for managing advertisements

(76) Inventors: Joseph C. Flynn, Saddle River, NJ (US); Kunmi Kim, Warren, NJ (US)

Correspondence Address: ROTHWELL, FIGG, ERNST & MANBECK, P.C., 1425 K STREET, N.W., SUITE 800, WASHINGTON, DC, 20005, US

(21) Appl. No.: 11/589,989

(22) Filed: Oct. 31, 2006

(51) Int. Cl. G06Q 30/00

(52) U.S. Cl. 705/14

(57) ABSTRACT

In one aspect, the present invention provides a computerized system and method for placing ads that is, among other things, less paper-intensive and less error prone than conventional advertising systems and methods.

### BACKGROUND OF THE INVENTION

1Field of the Invention

The present invention relates to the field of advertising, and, more specifically, provides systems and methods for managing advertisements (e.g., display ads, classified ads, and other advertisements).

2. Discussion of the Background

Placing an ad in a publication (e.g., a newspaper or other publication) is a paper-intensive process. A study in Sweden has shown that there can be as many as 16 transmissions of paper in connection with a single ad. Because the process is so paper-intensive it is also error prone; a single ad may have to be re-typed or re-formatted several times before it appears in a hard copy or online newspaper. Other disadvantages exist.

What is desired, therefore, are advertising systems and methods that overcome these and other disadvantages associated with the advertising process.

### SUMMARY OF THE INVENTION

The present invention provides such desired systems and methods. In one aspect, the present invention provides a computerized system and method for placing ads that is, among other things, less paper-intensive and less error prone than conventional advertising systems and methods.

One embodiment of the invention provides an article of manufacture comprising a computer-readable media storing computer-executable instructions for enabling an advertising advisor to create an advertisement. In one embodiment, the computer-executable instructions include: instructions for receiving a list of customer records that are associated with a single telephone number; instructions for displaying the list of customer records; instructions for enabling the advertising advisor to select a customer record from the list; instructions for displaying a graphical user interface comprising a window comprising a work area, said work area comprising: (1) customer information fields for displaying information from the selected customer record and for enabling the advertising advisor to edit at least some of the displayed information; (2) a word processor for enabling the advisor to input the text of an advertisement and to format the inputted text, and (3) a selectable control element; instruction for storing the text of the advertisement and corresponding formatting information; and instructions for adding the advertisement to a copy-passing list in response to the advisor selecting the control element.

The above and other embodiments of the present invention are described below with reference to the accompanying drawings.

### BRIEF DESCRIPTION OF THE DRAWINGS

The accompanying drawings, which are incorporated herein and form part of the specification, illustrate various embodiments of the present invention. In the drawings, like reference numbers indicate identical or functionally similar elements. Additionally, the left-most digit(s) of a reference number identifies the drawing in which the reference number first appears.

FIG. 1 is a high-level, functional, block diagram of one embodiment of the present invention.

FIG. 2 shows a process, according to one embodiment, that illustrates the basic flow of events that occur when a transient caller submits an ad.

FIGS. 3-13 illustrate various user interfaces according to one embodiment of the present invention.

### DETAILED DESCRIPTION OF PREFERRED EMBODIMENTS

As used herein, the words “a” and “an” mean “one or more.”

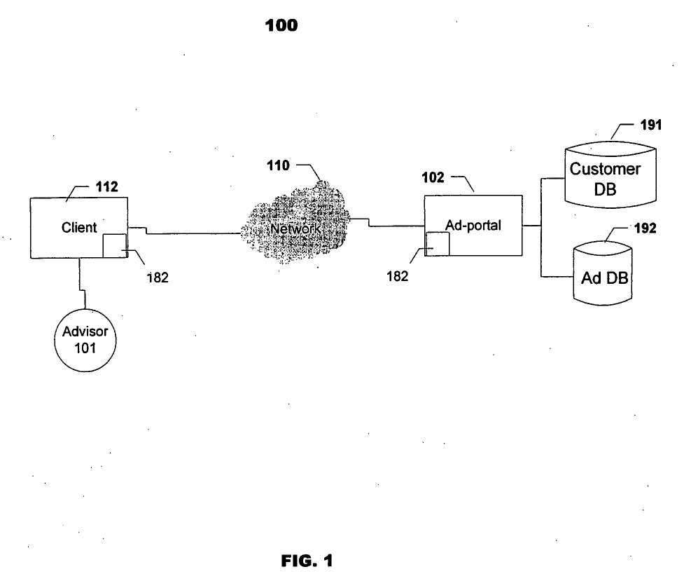

In one aspect, the present invention provides a computerized advertising system 100 (see FIG. 1). System 100 includes an ad-portal system 102, which enables users (such as user 101 or “advisor” 101) to enter ads electronically into ad-portal system 102 using a communication device (e.g., desktop computer, laptop computer, hand-held consumer electronic device, or other devices capable of transmitting and receiving data over a network) (“client”). For example, advisor 101 can use a conventional computer 112 to transmit to ad-portal 102, via a network 110, information concerning an ad that an advertiser would like to place in a publication, such as a traditional newspaper or on-line publication.

Ad-portal system 102 includes one or more computers and back-end software 181, which is stored on a computer readable medium and which may execute on one or more of the one or more computers. The back-end software processes requests and information received from client 112. Additionally, client 112 may have a computer readable medium for storing front-end software 182 and may execute the front-end software, which, when executed, enables advisor 101 to communicate with the back-end software and displays to the user information (e.g., information received from the back-end software). Other features and functionality of software 181 and 182 will be apparent from the description below.

Network 110 can be a public network (such as the Internet or public switched telephone network or other public network), a private network, a virtual private network, or any combination of these. Preferably, client 112 and ad-portal system 102 include software that enable them to communicate with each other using a standard protocol, such as, for example, the hypertext transfer protocol (HTTP) or other protocol.

In one embodiment of system 100 there are two types of advertisers: (1) contract advertisers and (2) non-contract advertisers (a.k.a., transient users). A contract user is a user that has entered into an advertising contact with a publishing company affiliated or associated with system 100, whereas a transient user may have no previous relationship with the publishing company.

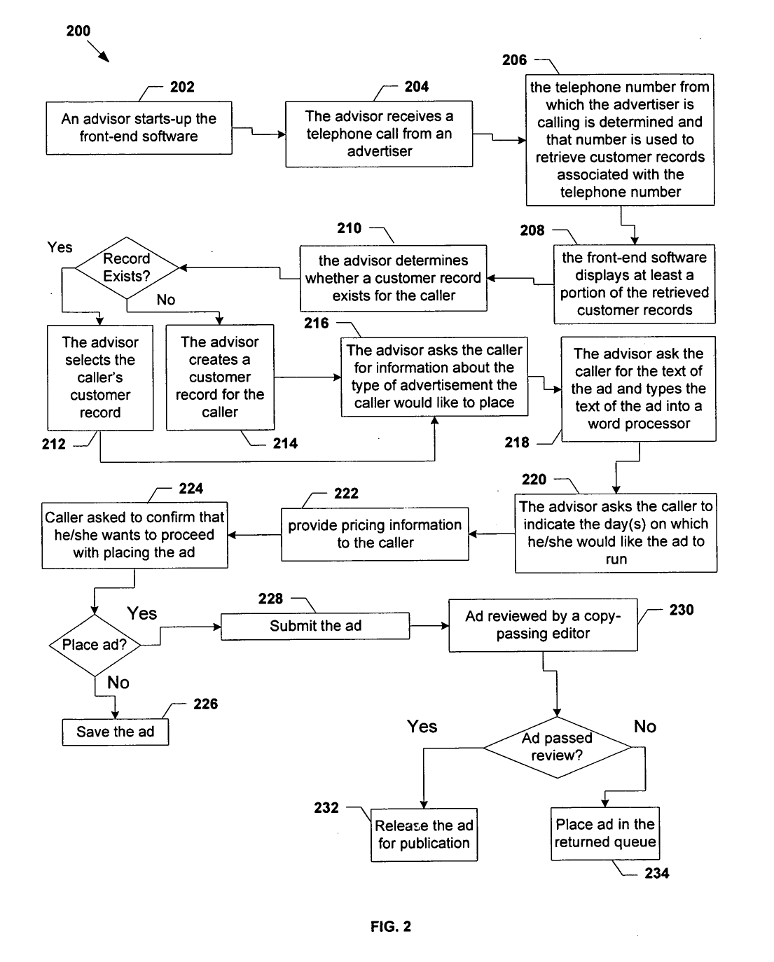

FIG. 2 is a flow chart illustrating a process 200, according to one embodiment, that occurs when a transient advertiser places an advertisement.

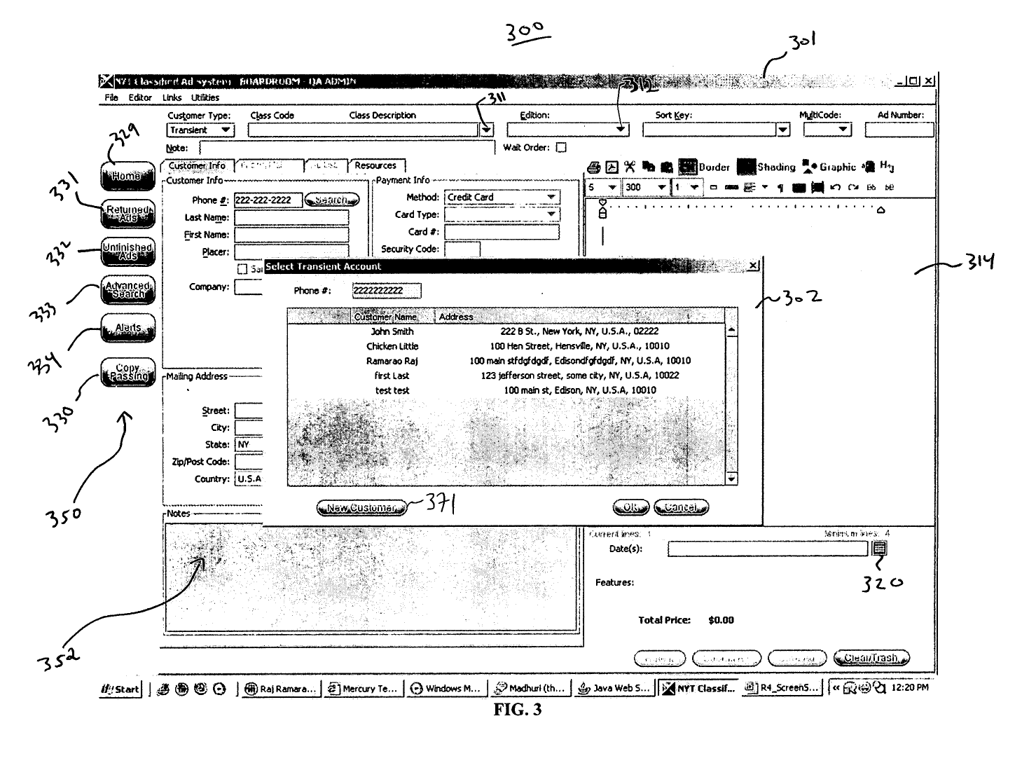

Process 200 may begin in step 202, where advisor 101 executes the front-end software using device 112, for example. FIG. 3 is a screen shot of an example user interface 300 proved by the front end-software. As shown in FIG. 3, interface 300 may be a single main window 301 that enables advisor 101 to input data (e.g., customer information, advertising copy, etc.) and perform various advertising related functions.

In step 204, advisor 101 receives a telephone call from the advertiser. In step 206, the telephone number from which the advertiser is calling is determined and that number is used to retrieve, from a database (e.g., customer database 191), customer records associated with the determined telephone number. For example, the back-end software may access the database and retrieve the records based on the determined telephone number.

In step 208, the front-end software displays at least a portion of the retrieved customer records (e.g., name and address) in a display window 302. In step 210, advisor 101 asks the caller for his/her name and address so that advisor 101 can determine whether a customer record exists for the caller. If a customer record does not exist for the caller, the process may proceed to step 212, otherwise it may proceed to step 214.

In step 212, advisor 101 activates the “new customer” control element 371 in window 302 and then creates a customer record for the caller (although control element 371 is shown as being a button, other control elements, such as menu options, may be used). For example, advisor 101 ask the caller for customer information (e.g., name, phone, mailing address, billing address, etc.) and inputs the information into a database update form (not shown). After step 212, process may proceed to step 216.

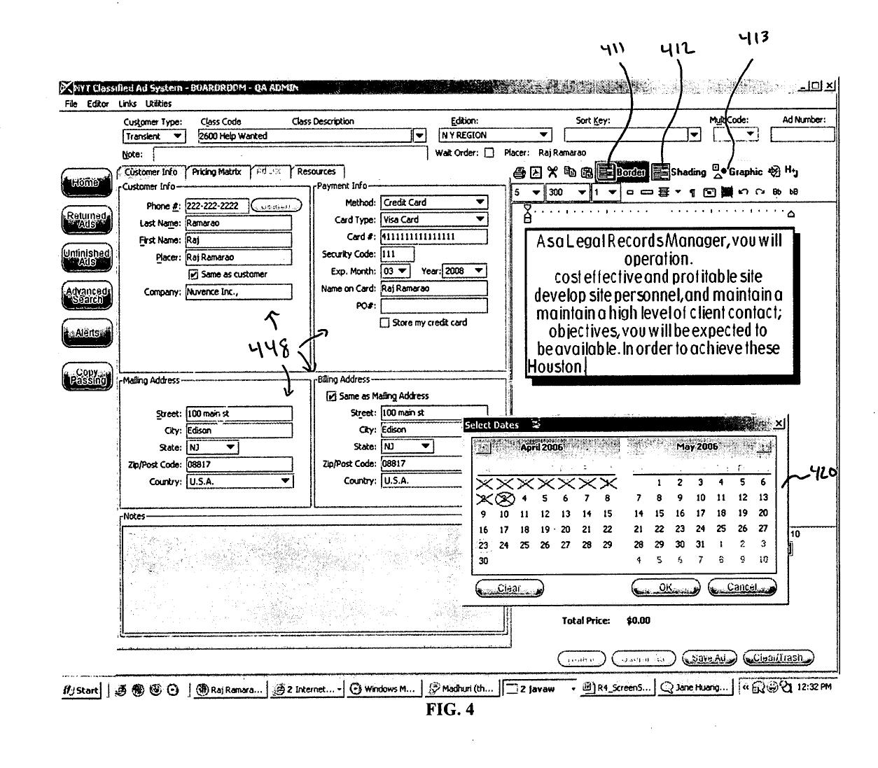

In step 214, advisor 101 selects from the list of customer records displayed in window 302 the caller's customer record and then activates the “ok” button in window 302. After activating the “ok” button the caller's customer information is displayed in various customer information fields 448 (see FIG. 4).

In step 216, advisor 101 asks the caller for information about the type of advertisement (e.g., help wanted, for sale, etc.) that the caller would like to place. After receiving this information, advisor 101 may select the desired advertising type from pull down menu 311. If there are multiple region editions into which the ad may be placed, advisor 101 may ask the caller to identify the desired region edition and then select the desired region edition from pull down menu 312.

In step 218, advisor 101 ask the caller for the text of the ad and types the text of the ad into word processor 314, which, in the embodiment shown, is a “what you see is what you get” (WYSIWYG) word processor that is included within main window 301. As shown in FIG. 4, word processor 314 enables advisor 101 to add a border to the text of the ad (see button 411), to add shading to the ad (see button 412), and to add a graphic (e.g., a logo) to the ad (see button 413).

In step 220, advisor 101 asks the caller to indicate the day(s) on which he/she would like the ad to run. After receiving this information from the caller, advisor 101 may input the dates to the front-end software by selecting the dates from calendar 420 (see FIG. 4) which is displayed when advisor 101 actives the calendar icon 320.

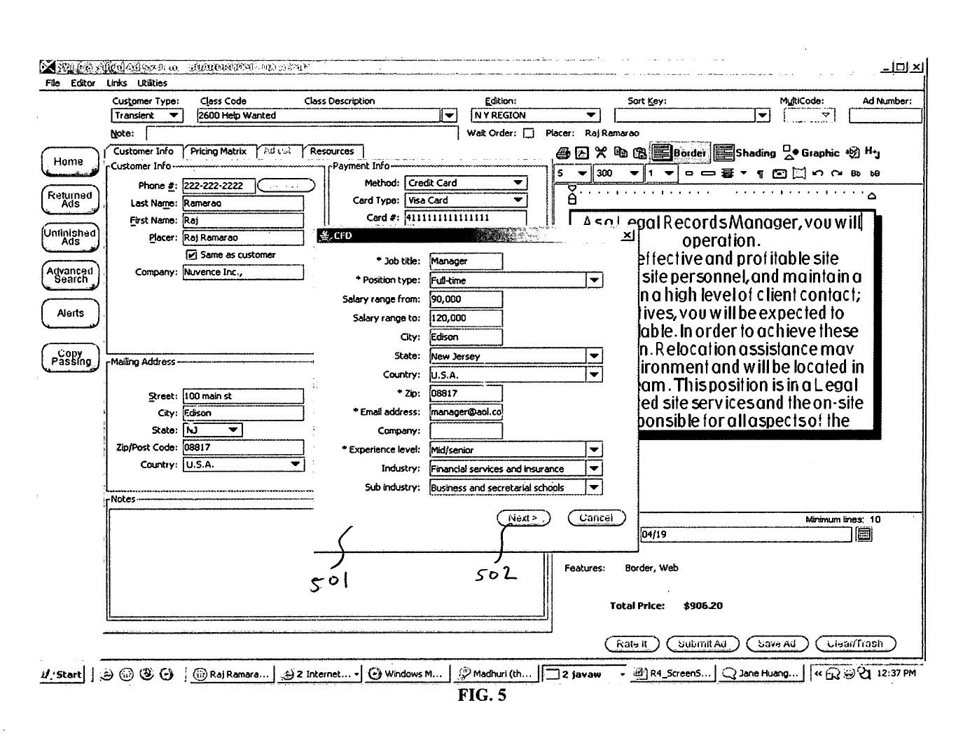

Depending on the type of ad, the front-end software may display a form 501 (see FIG. 5) that enables advisor 101 to input information about the ad being placed. That is, some types of ads have data fields with which they are associated. For instance, if the ad is a “help wanted” ad, then form 501 may include data fields related to the advertised job (e.g., job title, salary range, location of job, desired experience level, etc.). After advisor 101 enters the appropriate information into the fields of the form, advisor 101 may activate “next” button 502, which, in one embodiment, causes the front-end software to send the inputted information to the back-end software so that the back-end software can put the information in a database (e.g., database 192) and associate the information with the advertisement, the text and formatting of which may also be stored in the dataabse. This feature makes it easier for a person looking for a job to find the help wanted ads that advertise the types of jobs for which the person is looking.

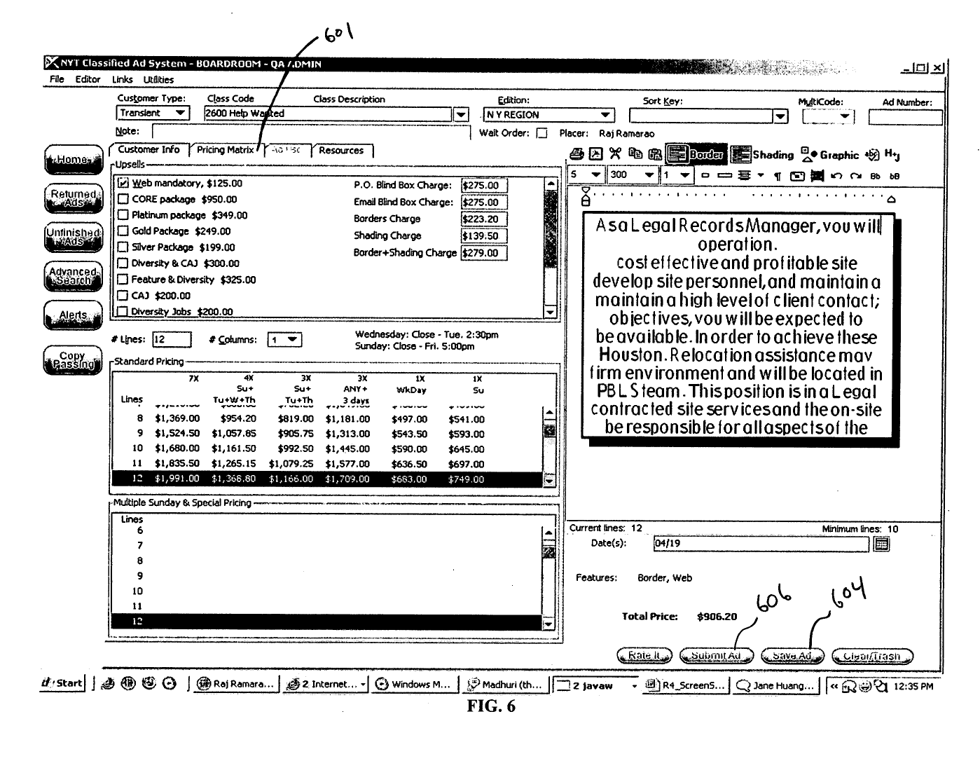

In step 222, after advisor 101 has created the ad using word processor 314, advisor 101 would provide pricing information to the caller. To facilitate advisor 101 in determining the price information, interface 300 includes a “pricing matrix” tab 601 (see FIG. 6). When advisor 101 select the pricing matrix tab 601, the front-end software displays pricing information (e.g., in the example shown, the pricing information is displayed in a portion of main window 301). As illustrated in FIG. 6, the pricing information may include a list of up-sells (e.g., different packages that the advertiser may purchase).

After the pricing information is given to the caller, the caller may be asked to confirm that he/she wants to proceed with placing the ad (step 224). If the caller does not wish to proceed or is unsure, advisor 101 may save the ad by activating the “save ad” button 604 (step 226). In one embodiment, activating save ad button 604 causes the ad information (e.g., the text of the ad and other ad information) to be saved in the ad database 192 and associated with caller information (e.g., the caller's name and/or telephone number) so that if the caller calls back at a later time, the ad information can be retrieved easily from database 192 using information about the caller.

If the caller wishes to proceed with placement of the ad, then advisor 101 may activate the “submit ad” button 606 (step 228). In one embodiment, activating submit ad button 606 causes the ad information to be saved in database 192 and associated with caller information and causes the ad to be placed in a copy-passing queue. The copy-passing queue is a list of ads that must be reviewed by an editor before the ad can be published.

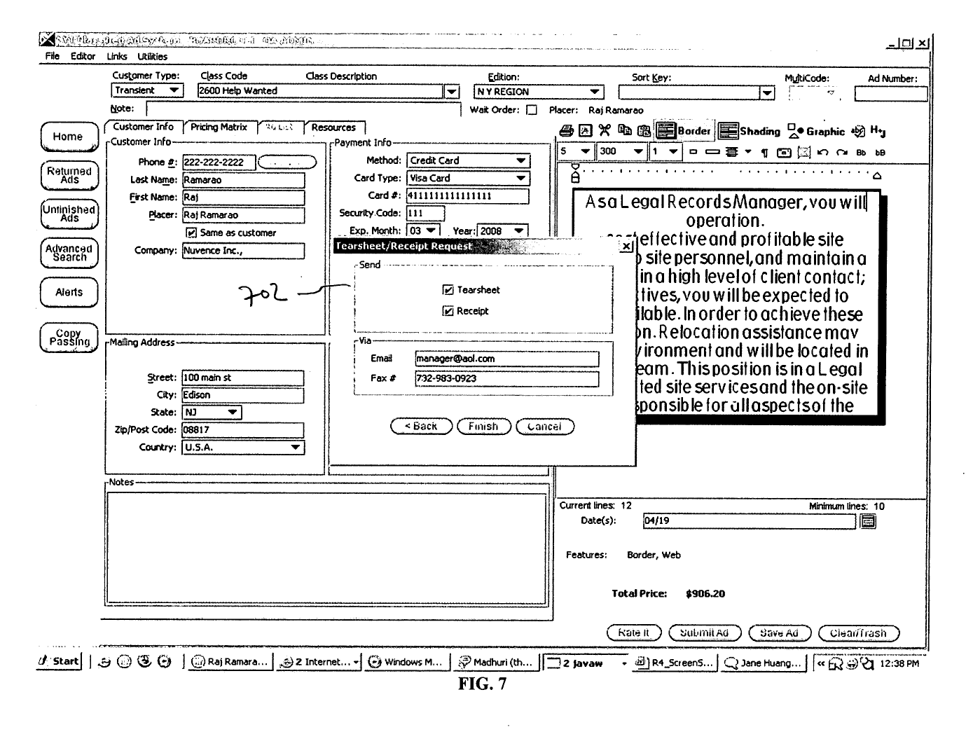

In step 228, front-end software may display a pop-up window 702 (see FIG. 7) that enables advisor 101 to configure system 100 to send to the caller's e-mail address and/or fax number a tear-sheet and/or a receipt. The tear-sheet is an image of the ad as it will appear when published. For example, if the ad is a classified ad that will run in a newspaper, the tear-sheet may be an image of the page of the newspaper in which the ad appears.

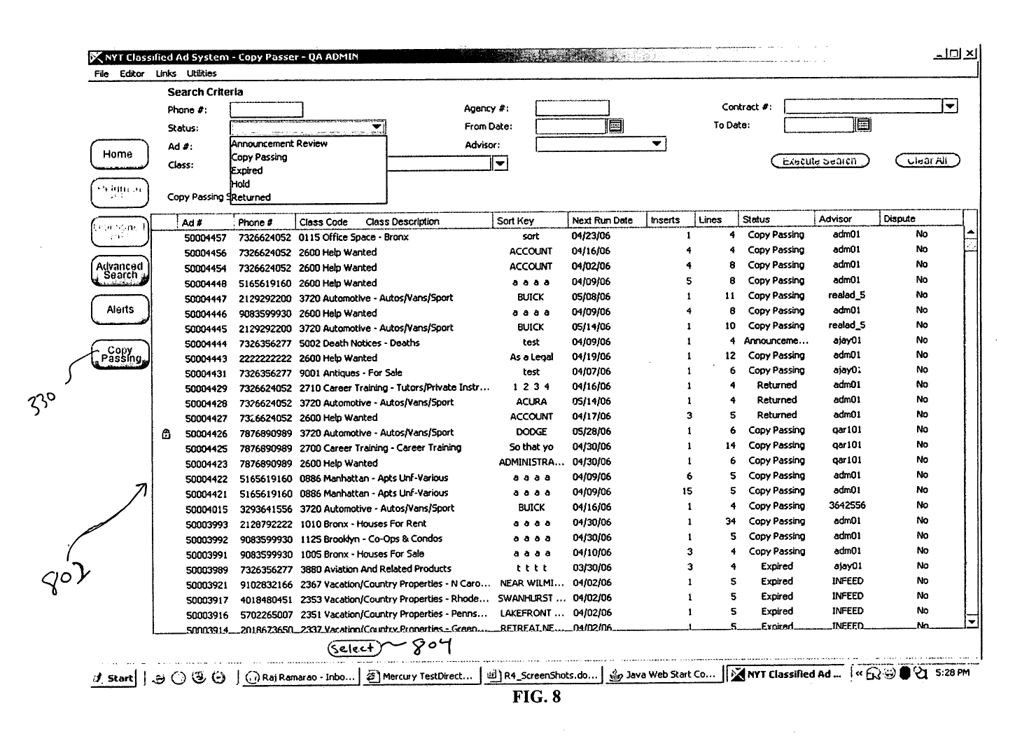

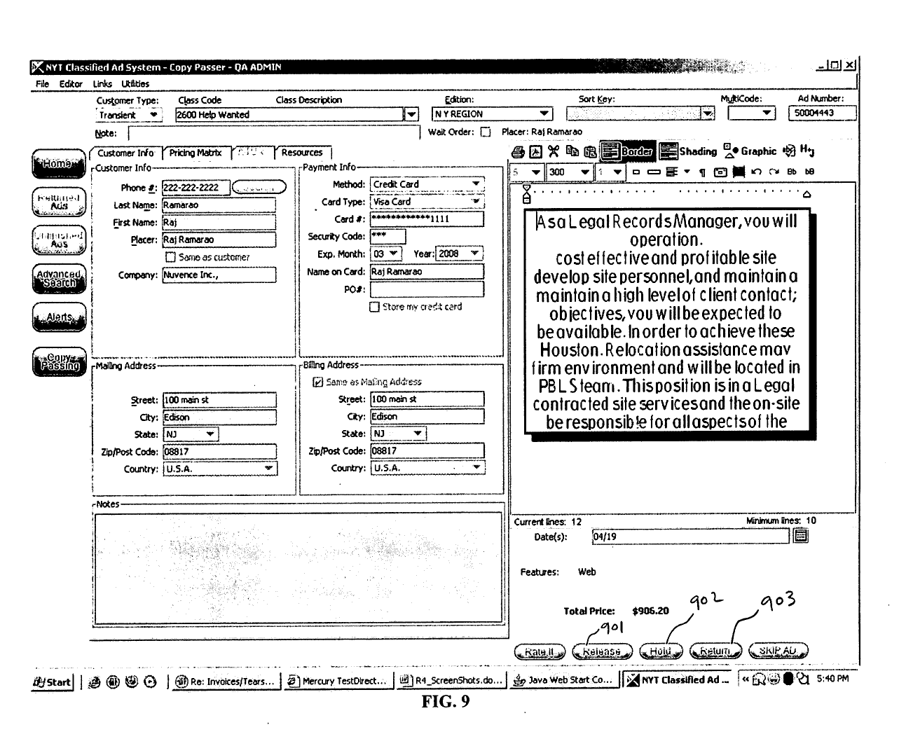

In step 230, a copy-passing editor will review the ad submitted by advisor 101. To do this, the editor may use the front-end software. Referring back to FIG. 1, interface 300 includes a “copy-passing” button 330. In response to the editor activating copy-passing button 330, the front-end software may display a list of ads 802 that are in the copy-passing queue (see FIG. 8). For example, front-end software may send a request to the back-end software to retrieve the queue so that front-end software can display it. To review an ad in the copy-passing queue, the editor can select the ad from list 802 and then activate “select” button 804. In one embodiment, selecting button 804 causes the front-end software to display the ad and a set of buttons that enable the editor to release, hold or return the ad. FIG. 9 illustrates this feature. As shown in FIG. 9, the front-end software displays the selected ad in the word processor 314 and provides a release button 901, a hold button 902 and a return button 903.

If the editor finds no problems with the ad, the editor may select release button 901 (step 232), which, in one embodiment, causes the ad to be removed from the copy-passing queue and released for publication. However, if the editor finds problems with the ad, the editor may return the ad to advisor 101 by activating return button 903 (step 234).

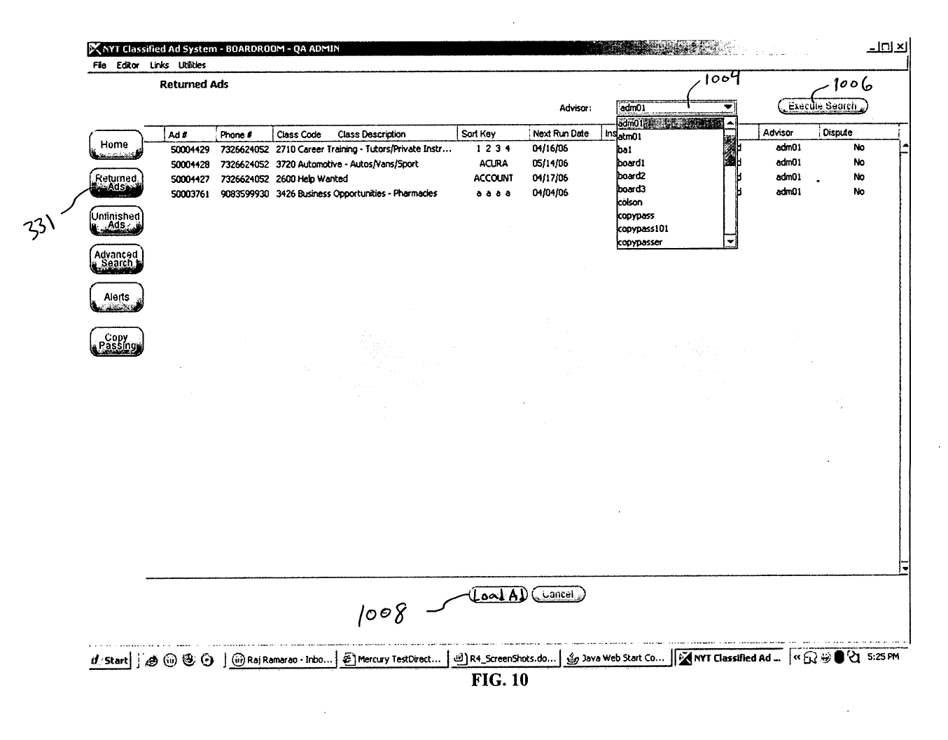

The front-end software enables advisor 101 to view the list of ads that have been returned. For example, in the embodiment shown in FIG. 1, window 301 includes a “returned ads” button 331. In one embodiment, in response to advisor 101 activating button 331, the front-end software will display a list of ads 1002 (see FIG. 10) that have been returned to the advisor by the copy-passing editor. If advisor 101 wants to see the ads that have been returned to another advisor, advisor 101 can select the other advisor from pull-down menu 1004 and the activate the “execute search” button 1006. If advisor 101 wants to view and edit one of the returned ads, then advisor 101 can select the ad and then activate “load ad” button 1008, which may cause the front-end software to display window 301 with the text of the ad being loaded into word processor 314.

Referring back to FIG. 3, in the embodiment shown main window 301 includes a vertical button panel 350 and a work area 352. As illustrated in the other figures, work area 322 changes depending on which button is currently active. For example, FIG. 1 shows the work area 352, according to one embodiment, after the user activates home button 329, FIG. 10 shows the work area 352, according to one embodiment, after the user activates returned ads button 331, and FIG. 8 shows the work area 352, according to one embodiment, after the user activates copy passing button 330.

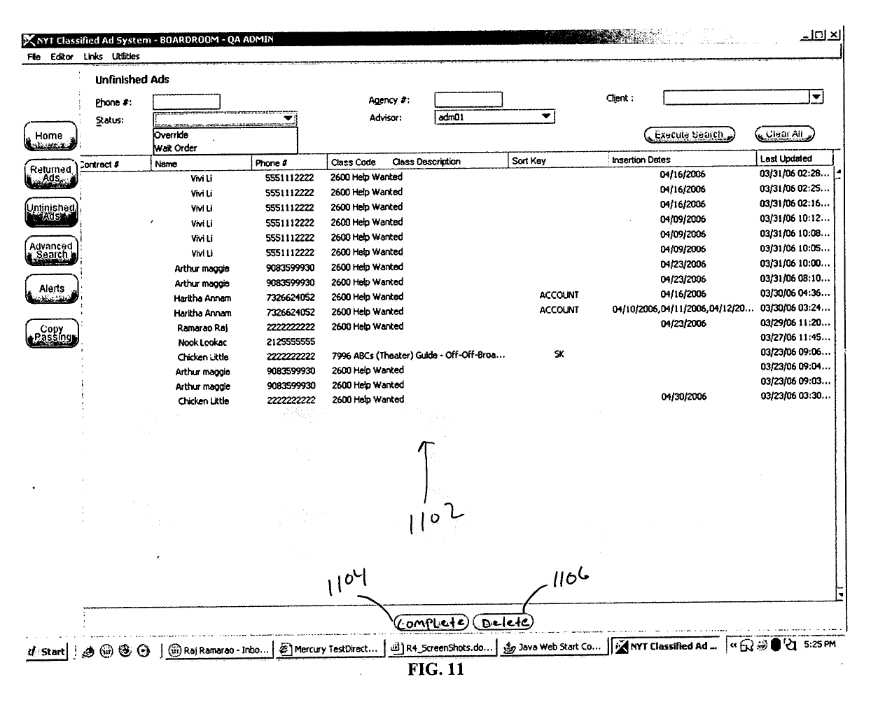

Referring now to FIG. 11, FIG. 11 shows the work area 352, according to one embodiment, after the user activates unfinished ads button 332. As shown in FIG. 11, work area 352 displays a list of unfinished ads 1102. Unfinished ads are those ads that the advisor has previously saved using button 604. Advisor 101 can resume work on an unfinished ad simply by selecting the ad from list 1102 and then activating the “complete” button 1104. In one embodiment, this causes work area 352 to return to its home state (see FIG. 4, for example) with the text of the selected ad loaded into word processor 314 and the other ad information loaded into the customer information fields 448. Advisor 101 may also delete an unfinished ad simply by selecting the ad from list 1102 and then activating the “delete” button 1106.

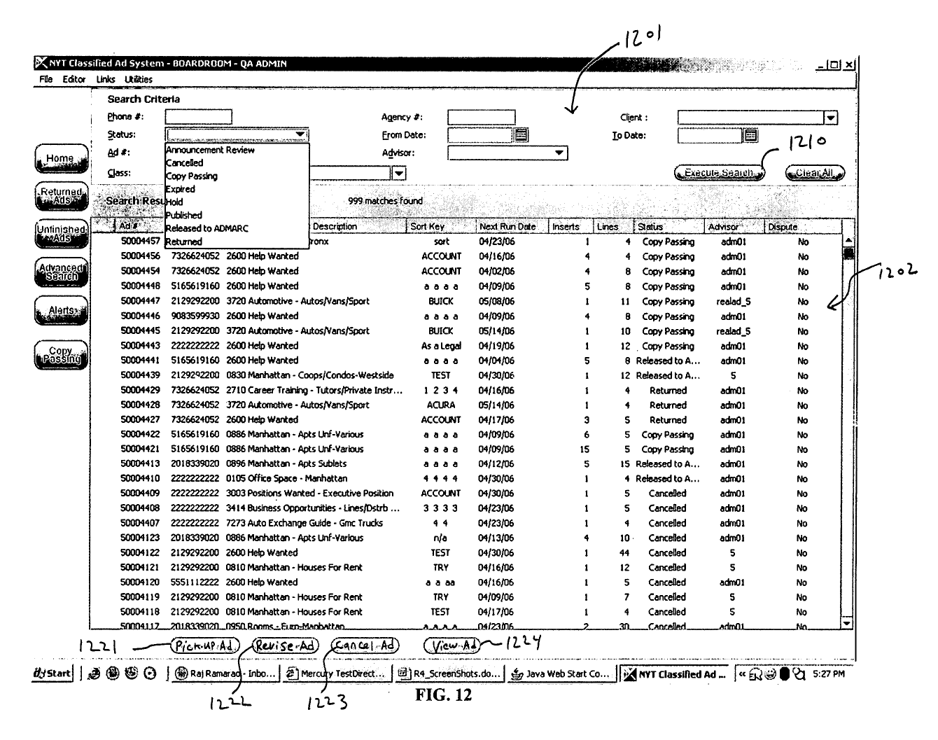

Referring now to FIG. 12, FIG. 12 shows work area 352, according to one embodiment, after the user activates the “advanced search” button 334. As shown in FIG. 12, work area 352 includes a search form 1201 and a results window 1202. As illustrated, search form 1201 may include various fill-in fields that enable the advisor to construct a query (i.e., specify search criteria). That is, the advisory uses form 1201 to specify the ads that the advisor is searching for.

As illustrated, an advisor can search for ads based on, at the least, one or more of the following: the phone number of the customer who placed the ad, the status of the ad, the ad number, the ad class, ad run dates, and the advisor who inputted the ad into the system. After the advisor specifies the search criteria using form 1201, the advisor may activate the “execute search” button 1210. In response to activation of button 1210, in some embodiments, the front-end software communicates the search criteria to the back-end software, which then uses the criteria to retrieve ad records from database 192 and to return the retrieved information to the front-end software, which may display at least some of the returned information in results window 1202.

As further illustrated in FIG. 12, an advisor can perform a number of operations on an ad that is displayed in results window 1202. For example, the advisor may (1) re-run a previously published ad by selecting the “pick-up ad” button 1221, (2) revise the ad by selecting the “revise ad” button 1222, (3) cancel the ad by selecting the “cancel ad” button 1223, or (4) view the ad by selecting the “view ad” button 1224. In some embodiments, after an advisor selects an ad from results window 1202 and activates pick-up ad button 1221, the advisor is prompted to specify the run dates for the ad. After the advisor specifies the run dates, the ad is automatically published on those dates.

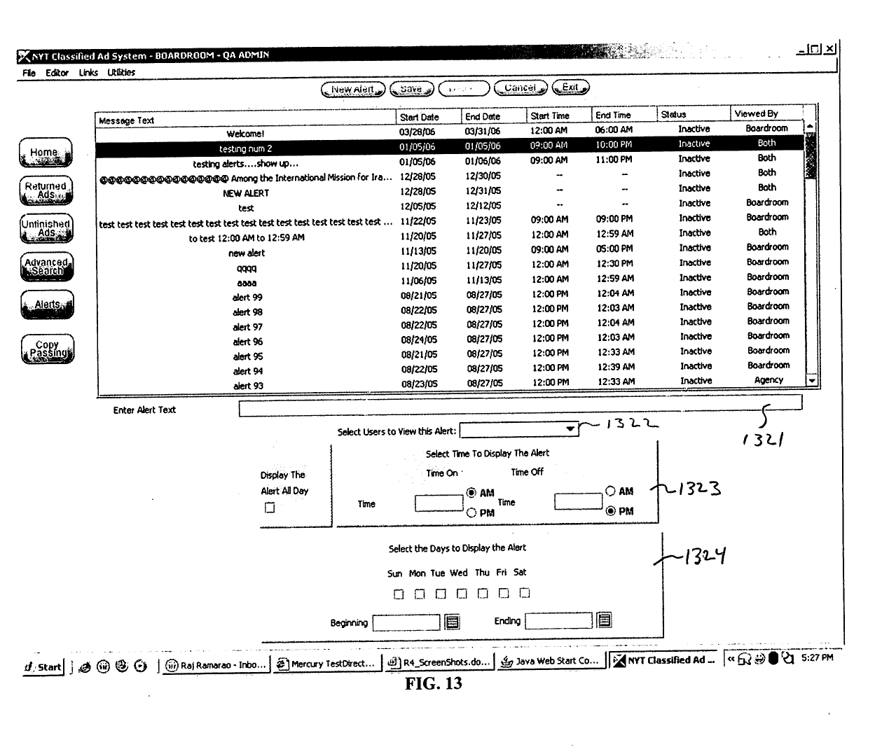

Referring now to FIG. 13 shows work area 352, according to one embodiment, after the user activates the “alerts” button 334. As shown in FIG. 13, work area 352 includes an alert creation form 1301 and an alert list window 1302. As illustrated, alert creation form 1301 may include various fill-in fields that enable the advisor to crate an alert.

As illustrated in FIG. 13, in one embodiment, an advisor creates an alert by entering the text for the alert into input field 1321, selecting the recipients for the alert using pull-down menu 1322, specifying the time to display the alert using input fields 1323, and selecting the days to display the alert using input fields 1324. On the specified day and time, the system will display the alert to the selected recipients of the alert. In this way, a user of the system can send timed messages to one or more people.

While various embodiments/variations of the present invention have been described above, it should be understood that they have been presented by way of example only, and not limitation. Thus, the breadth and scope of the present invention should not be limited by any of the above-described exemplary embodiments.

Additionally, while the processes described above and illustrated in the drawings are shown as a sequence of steps, this was done solely for the sake of illustration. Accordingly, it is contemplated that some steps may be added, some steps may be omitted, and the order of the steps may be re-arranged.

What is claimed is:

1. An article of manufacture comprising a computer-readable media storing computer-executable instructions for enabling an advertising advisor to create an advertisement, the computer-executable instructions comprising:
instructions for receiving a list of customer records that are associated with a single telephone number;
instructions for displaying the list of customer records;
instructions for enabling the advertising advisor to select a customer record from the list;
instructions for displaying a graphical user interface comprising a window comprising a work area, said work area comprising: (1) customer information fields for displaying information from the selected customer record and for enabling the advertising advisor to edit at least some of the displayed information; (2) a word processor for enabling the advisor to input the text of an advertisement and to format the inputted text, and (3) a selectable control element;
instruction for storing the text of the advertisement and corresponding formatting information; and
instructions for adding the advertisement to a copy-passing list in response to the advisor selecting the control element.

2. The article of manufacture of claim 1, wherein:
the window further comprises a returned ads button; and
the computer-executable instructions further comprise instructions for displaying a list of returned advertisements in response to the advisor selecting the returned ads button.

3. The article of manufacture of claim 2, wherein the instructions for displaying the list of returned advertisements includes instructions for displaying the list in said work area of said window.

4. The article of manufacture of claim 2, wherein:
the window further comprises an unfinished ads button; and
the computer-executable instructions further comprise instructions for displaying a list of unfinished advertisements in response to the advisor selecting the unfinished ads button.

5. The article of manufacture of claim 4, wherein the instructions for displaying the list of unfinished advertisements includes instructions for displaying the list in said work area of said window.

6. The article of manufacture of claim 4, wherein:
the window further comprises a search button; and
the computer-executable instructions further comprise instructions for displaying a search form in response to the advisor selecting the search button, wherein said search form is configured to enable the advertiser to specify an advertisement search criteria.

7. A method, comprising:
receiving a list of customer records that are associated with a single telephone number;
displaying the list of customer records;
enabling an advertising advisor to select a customer record from the list;
displaying a graphical user interface comprising a window comprising a work area, said work area comprising: (1) customer information fields for displaying information from the selected customer record and for enabling the advertising advisor to edit at least some of the displayed information; (2) a word processor for enabling the advisor to input the text of an advertisement and to format the inputted text, and (3) a selectable control element;
storing the text of the advertisement and corresponding formatting information; and
adding the advertisement to a copy-passing list in response to the advisor selecting the control element.

8. The method of claim 7, wherein:
the window further comprises a returned ads button; and
the method further comprises displaying a list of returned advertisements in response to the advisor selecting the returned ads button.

9. The method of claim 8, wherein the step of displaying the list of returned advertisements includes displaying the list in said work area of said window.

10. The method of claim 8, wherein:
the window further comprises an unfinished ads button; and
the method further comprises displaying a list of unfinished advertisements in response to the advisor selecting the unfinished ads button.

11. The method of claim 10, wherein step of displaying the list of unfinished advertisements includes displaying the list in said work area of said window.

12. The method of claim 4, wherein:
the window further comprises a search button; and
the method further comprises displaying a search form in response to the advisor selecting the search button, wherein said search form enables the advertiser to specify an advertisement search criteria.

13. An advertising system, comprising:
means for receiving a list of customer records that are associated with a single telephone number;
means for displaying the list of customer records;
means for enabling an advertising advisor to select a customer record from the list;
means for displaying a graphical user interface comprising a window comprising a work area, said work area comprising: (1) customer information fields for displaying information from the selected customer record and for enabling the advertising advisor to edit at least some of the displayed information; (2) a word processor for enabling the advisor to input the text of an advertisement and to format the inputted text, and (3) a selectable control element;
means for storing the text of the advertisement and corresponding formatting information; and
means for adding the advertisement to a copy-passing list in response to the advisor selecting the control element.

14. The system of claim 1, wherein:
the window further comprises a returned ads button; and
the system further comprises means displaying a list of returned advertisements in response to the advisor selecting the returned ads button.

15. The system of claim 14, wherein the means for displaying the list of returned advertisements includes means for displaying the list in said work area of said window.

16. The system of claim 14, wherein:
the window further comprises an unfinished ads button; and
the system further comprises means for displaying a list of unfinished advertisements in response to the advisor selecting the unfinished ads button.

17. The system of claim 16, wherein the means for displaying the list of unfinished advertisements includes means for displaying the list in said work area of said window.

18. The system of claim 16, wherein:
the window further comprises a search button; and
the system further comprises means for displaying a search form in response to the advisor selecting the search button, wherein said search form is configured to enable the advertiser to specify an advertisement search criteria.
